(19) United States
(12) Patent Application Publication
(10) Pub. No.: US 2026/0296331 A1
(43) Pub. Date: Oct. 1, 2026

(54) MOUNTING ASSEMBLY FOR AN OUTDOOR ELEMENT OF A VEHICLE

(71) Applicant: Motherson Innovations Company Limited, London (GB)

(72) Inventors: Ralf Tiekenheinrich, Esslingen (DE); Norbert Nemeth, Stuttgart (DE)

(21) Appl. No.: 19/572,244

(22) Filed: Mar. 19, 2026

(30) Foreign Application Priority Data
Mar. 25, 2025 (DE) 102025111447.1

(51) Int. Cl. B60R 11/04; B60R 1/06; B62D 65/16

(52) U.S. Cl. CPC B60R 11/04; B60R 1/06; B62D 65/16

(57) ABSTRACT

The present disclosure relates to a mounting assembly for an outdoor element of a vehicle. The mounting assembly comprises a bracket and an adaptor. The bracket comprises a first surface and a second surface, wherein the first surface of the bracket is configured to be in contact with an exterior of the vehicle. The adaptor is configured to cover the second surface of the bracket, wherein at least a portion of the adaptor is configured to be sandwiched between the outdoor element and the bracket when mounting the outdoor element to the bracket.

### CROSS-REFERENCE TO RELATED APPLICATIONS

This application claims the benefit of priority to German Patent Application DE 10 2025 111 447.1, filed on Mar. 25, 2025, which is incorporated herein by reference in its entirety.

### BACKGROUND

The present disclosure relates to a mounting assembly for an outdoor element of a vehicle.

Mounting of outdoor element on a vehicle is well known in industry. As the name indicate, the outdoor element is exposed to environment. The outdoor element may be, but not limited to, a camera, an exterior rear-view mirror, a light emitting unit, a frame and a wing-arm. However, the outdoor element is mounted on the vehicle with help of a bracket. The bracket act as an intermediate member between the outdoor element and the vehicle. The bracket is mounted to an exterior surface of the vehicle. Further, the outdoor element is mounted on the bracket. The existing brackets are made up of cast iron, which make them susceptible to rusting or other environmental degradation. This results in short life span of the brackets and unreliable mounting for the outdoor element.

Thus, the object of the present disclosure is to develop a mounting assembly for the outdoor element, which overcome the above-mentioned challenges.

This object is achieved by a mounting assembly for an outdoor element of a vehicle as defined in the independent claims. Advantageous configurations, embodiments and developments emerge from the further dependent claims and from the description with reference to the figures of the drawings.

Thus, the present disclosure provides mounting assembly for an outdoor element of a vehicle, the mounting assembly comprising: a bracket, having a first surface and a second surface, configured to be mounted on an exterior of the vehicle, wherein the first surface of the bracket is configured to be in contact with the exterior of the vehicle, and an adaptor configured to cover the second surface of the bracket, wherein at least a portion of the adaptor is configured to be sandwiched between the outdoor element and the bracket when mounting the outdoor element to the bracket. The present disclosure provides a weatherproof and reliable mounting assembly for the outdoor element.

### SUMMARY

In an embodiment of the present disclosure, the bracket is configured to be mounted on the exterior of the vehicle by means of a first set of fasteners. In an embodiment of the present disclosure, the bracket is shaped to conform with the exterior of the vehicle. This enables reliable mounting of the bracket on to the vehicle. In an embodiment of the present disclosure, the adaptor is secured on the second surface of the bracket by means of a second set of fasteners. This enables reliable mounting of the adaptor on to the bracket. In an embodiment of the present disclosure, the adaptor is configured to cover the second surface of the bracket from at least one of the environmental factors. The environmental factor is water, dust and heat. In an embodiment of the present disclosure, the adaptor is shaped to conform with the second surface of the bracket. In an embodiment of the present disclosure, the adaptor is made up of a plastic material or a metallic material. This enables weatherproofing of the bracket. In an embodiment of the present disclosure, mounting of the outdoor element to the bracket is done by means of a third set of fasteners. This enables reliable mounting of the outdoor element on to the bracket. In an embodiment of the present disclosure, a sealant for sealing the bracket and is mounted between the adaptor and the outdoor element. This enables additional sealing for the bracket.

In an embodiment, the present disclosure also relates to a vehicle comprising: a mounting assembly according to any of the previous embodiments, and a rearview unit as the outdoor element mounted to the bracket of the mounting assembly. In an embodiment of the present disclosure, the rearview unit comprises at least one of a camera and a mirror.

The foregoing summary is illustrative only and is not intended to be in any way limiting. In addition to the illustrative aspects, embodiments, and features described above, further aspects, embodiments, and features will become apparent by reference to the drawings and the following detailed description.

It should be understood that any one of the described features and/or embodiments of the disclosure may be used separately or in combination with other disclosed features and/or embodiments.

### BRIEF DESCRIPTION OF THE DRAWINGS

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

FIG. 1 illustrates a perspective view of a mounting assembly with an exterior of a vehicle and an outdoor element in accordance with an embodiment present disclosure;

FIG. 2 illustrates schematic view of the mounting assembly excluding fasteners in accordance with an embodiment of the present disclosure;

FIG. 3 illustrates schematic view of the mounting assembly including fasteners in accordance with an embodiment of the present disclosure;

FIG. 4 illustrates a perspective view of a bracket in accordance with an embodiment present disclosure;

FIG. 5 illustrates a perspective view of an adaptor in accordance with yet another embodiment of the present disclosure; and

FIG. 6 illustrates a perspective view of the bracket of FIG. 4 and the adaptor of FIG. 5 together in accordance with yet another embodiment of the present disclosure.

### DETAILED DESCRIPTION

The drawings referred to in this description are not to be understood as being drawn to scale except if specifically noted, and such drawings are only exemplary in nature.

The foregoing objects, features and advantages of the present disclosure will become more apparent from the following detailed description related to the accompanying drawings. However, various modifications may be applied to the present disclosure, and the present disclosure may have various embodiments. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, like reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

While the present disclosure is illustrated in the context of a four-wheeled vehicle, however, holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

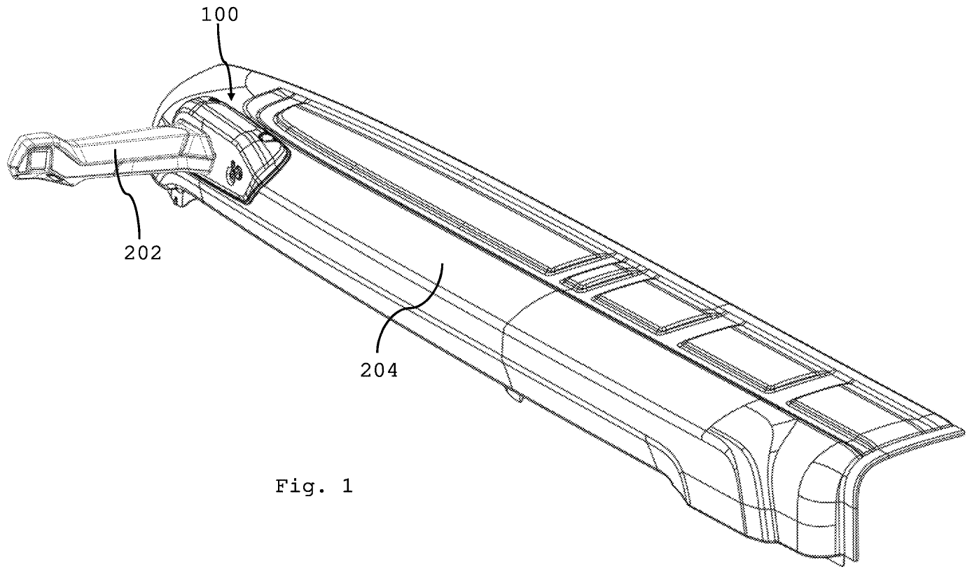

FIG. 1 shows a mounting assembly 100 configured for mounting an outdoor element 202 of a vehicle. The outdoor element 202 is configured to mount on an exterior 204 of the vehicle. As the name indicate, the outdoor element 202 is exposed to environment. The outdoor element 202 may be, but not limited to, a camera, an exterior rear-view mirror, a light emitting unit, a frame and a wing-arm. FIG. 1 shows the wing-arm as the outdoor element 202. In an embodiment, the outdoor element 202 is a rear-view unit comprising at least one of a camera and a mirror. Further, the exterior 204 may be outer surface of the vehicle. The exterior 204 may be, but not limited to, a cabin, a roof, a door panel and a body panel.

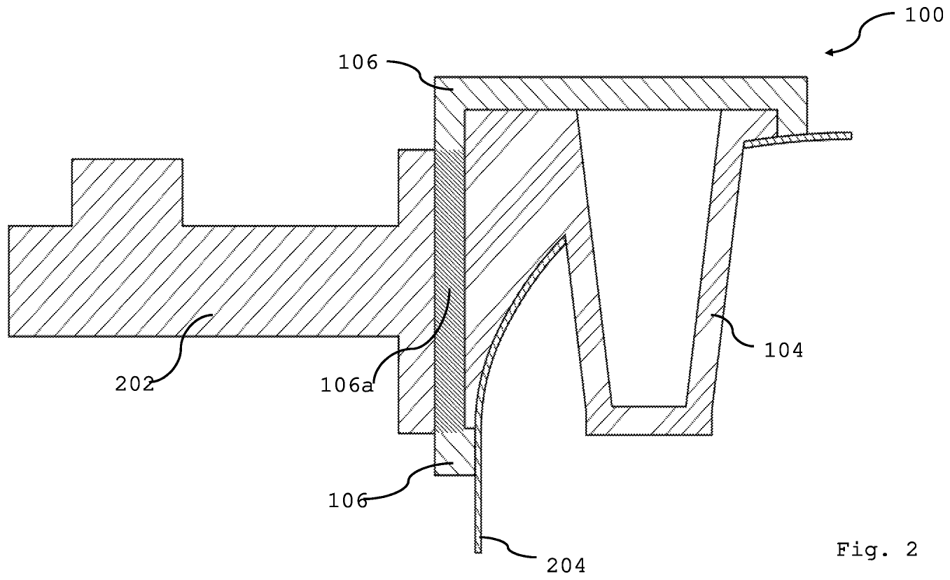

FIG. 2 shows the mounting assembly 100 encompassing a bracket 104 and an adaptor 106. It is shown that the bracket 104 is mounted on the exterior 204 of the vehicle. Further, the adaptor 106 is configured to cover the bracket 104. Furthermore, the adaptor 106 is configured to mount the outdoor element 202.

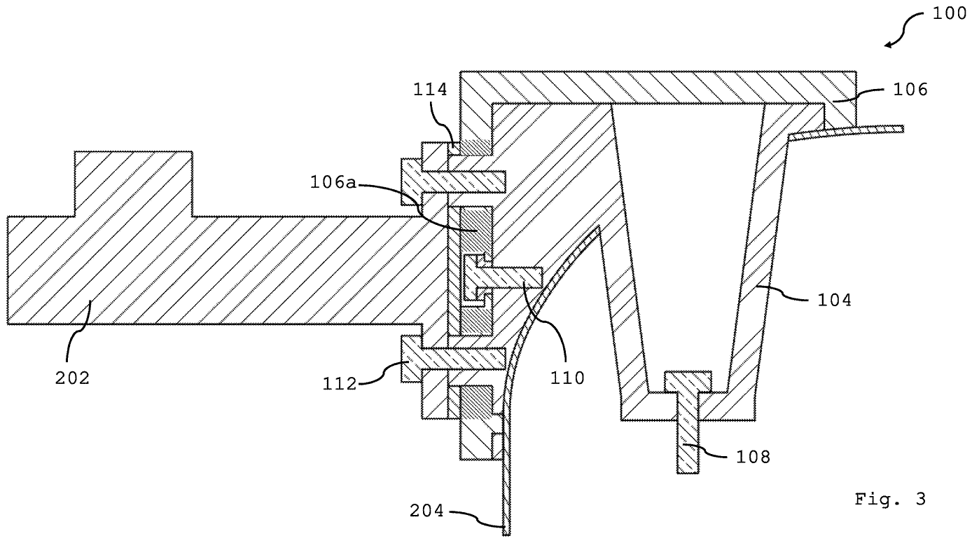

FIG. 3 shows the mounting assembly 100 as shown in FIG. 2 with a first set of fasteners 108, a second set of fasteners 110, and a third set of fasteners 112. As shown, the bracket 104 is configured to be mounted on the exterior 204 of the vehicle by means of the first set of fasteners 108. Similarly, the adaptor 106 is configured to be secured on the bracket 104 by means of the second set of fasteners 110 and thereby enabling the adaptor 106 to cover the bracket 104. Further, the mounting of the outdoor element 202 to the bracket 104 is done by means of the third set of fasteners 112.

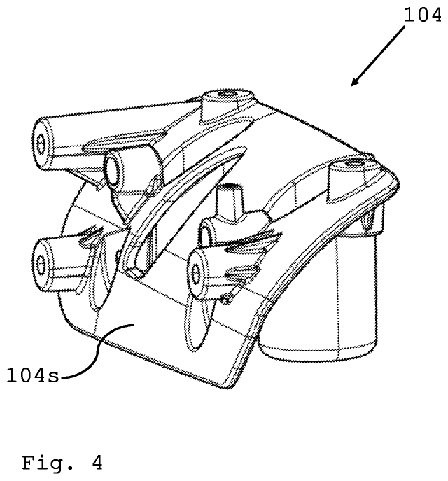

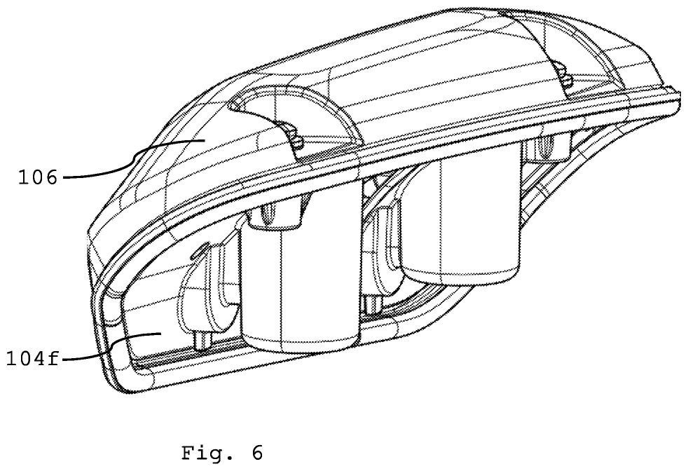

Further, FIG. 4 shows a perspective view of the bracket 104. The bracket 104 is configured to be mounted on the exterior 204 of the vehicle by means of the first set of fasteners 108. Further, the bracket 104 may be made up of an iron-based material. Further, the bracket 104 is shaped to conform with the exterior 204 of the vehicle to ensure effective mounting. Furthermore, the bracket 104 has a first surface 104f (as shown in FIG. 6) and a second surface 104s. The first surface 104f is configured to be in contact with the exterior 204 of the vehicle whereas the second surface 104s is configured to be covered by the adaptor 106. In other words, the second surface 104s may be exposed to the environment in the absence of the adaptor 106. Furthermore, as shown in FIGS. 3-4, a portion 106a of the adaptor 106 is configured to be sandwiched between the outdoor element 202 and the bracket 104 when mounting the outdoor element 202 to the bracket 104. In other words, the portion 106a of the adaptor 106 is in contact with outdoor element 202 when the outdoor element 202 is mounted on the second surface 104s of the bracket 104 by means of the third set of fasteners 112. Further, the first set of fasteners 108, the second set of fasteners 110, and the third set of fasteners 112 may be screws or any other fastening means known to a person ordinarily skilled in the art. In an yet another embodiment, a sealant 114 may be mounted between the adaptor 106 and the outdoor element 202 to seal the bracket 104. The sealant 114 prevents environmental influences affecting the bracket 104, so that this may result in an increase of the life of the bracket 104.

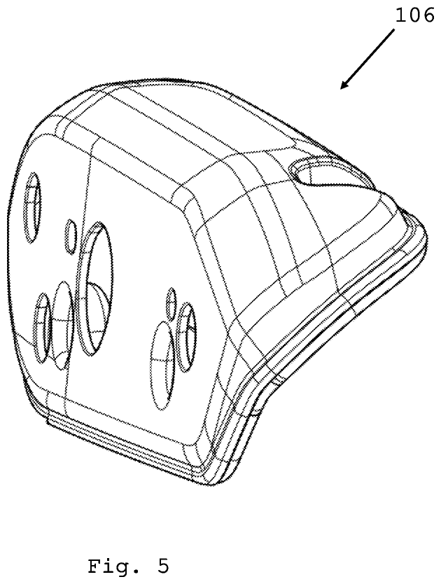

FIG. 5 shows a perspective view of the adaptor 106. As described above, the adaptor 106 is secured on the second surface 104s of the bracket 104 by means of the second set of fasteners 110 and thereby enabling the adaptor 106 to cover the second surface 104s of the bracket 104. Further, as shown in FIG. 6, the adaptor 106 is shaped to conform with the second surface 104s (as shown in FIG. 4) of the bracket 104. Further, the adaptor 106 may be made up of a plastic material or a metallic material. This may ensure shielding of the second surface 104s of the bracket 104 from at least one of environmental factor. The environmental factor may be at least one of water, dust or heat. This results in increased life span of the bracket 104 and provides a reliable mounting for the outdoor element 202. In addition, FIG. 6 also shows the first surface 104f of the bracket 104 configured to be in contact with the exterior 204 of the vehicle.

Therefore, the present disclosure provides a mounting assembly 100 with larger life span of the bracket 104 and reliable mounting for the outdoor element 202.

It will be appreciated by those skilled in the art that changes could be made to the embodiments described above without departing from the broad inventive concept thereof. It is understood, therefore, that the invention disclosed herein is not limited to the particular embodiments disclosed and is intended to cover modifications within the spirit and scope of the present invention.

### LIST OF REFERENCES

100 mounting assembly
104 bracket
104f first surface of bracket
104s second surface of bracket
106 adaptor
106a portion of adaptor
108 first set of fasteners
110 second set of fasteners
112 third set of fasteners
114 sealant
202 outdoor element
204 exterior surface

What is claimed is:

1. A mounting assembly for an outdoor element of a vehicle, the mounting assembly comprising:
a bracket, having a first surface and a second surface, configured to be mounted on an exterior of the vehicle, wherein the first surface of the bracket is configured to be in contact with the exterior of the vehicle; and
an adaptor configured to cover the second surface of the bracket, wherein at least a portion of the adaptor is configured to be sandwiched between the outdoor element and the bracket when mounting the outdoor element to the bracket.

2. The mounting assembly according to claim 1, wherein the bracket is configured to be mounted on the exterior of the vehicle by means of a first set of fasteners.

3. The mounting assembly according to claim 1, wherein the adaptor is secured on the second surface of the bracket by means of a second set of fasteners.

4. The mounting assembly according to claim 1, wherein the adaptor is configured to cover the second surface of the bracket from at least one of the environmental factor.

5. The mounting assembly according to claim 4, wherein the environmental factor is water, dust and heat.

6. The mounting assembly according to claim 1, wherein mounting of the outdoor element to the bracket is done by means of a third set of fasteners.

7. The mounting assembly according to claim 1, wherein the bracket is shaped to conform with the exterior of the vehicle.

8. The mounting assembly according to claim 1, wherein the adaptor is shaped to conform with the second surface of the bracket.

9. The mounting assembly according to claim 1, wherein the adaptor is made up of a plastic material or a metallic material.

10. The mounting assembly according to claim 6, further comprising a sealant for sealing the bracket and is configured to be mounted between the adaptor and the outdoor element.

11. A vehicle comprising:
a mounting assembly according to claim 1, and
a rearview unit as the outdoor element mounted to the bracket of the mounting assembly.

12. The vehicle according to claim 11, wherein the rearview unit comprises at least one of a camera and a mirror.

13. A mounting assembly for an outdoor element of a vehicle, the mounting assembly comprising:
a bracket, having a first surface and a second surface, configured to be mounted on an exterior of the vehicle, wherein the first surface of the bracket is configured to be in contact with the exterior of the vehicle;
an adaptor configured to cover the bracket, wherein at least a portion of the adaptor is configured to be sandwiched between the outdoor element and the bracket when mounting the outdoor element to the bracket; and
a sealant for sealing the bracket and configured to be mounted between the adaptor and the outdoor element, wherein the adaptor is secured on the second surface of the bracket by means of a second set of fasteners.
